(19) United States
(12) Patent Application Publication
(10) Pub. No.: US 2026/0338160 A1
(43) Pub. Date: Oct. 29, 2026

(54) POWER GENERATION SYSTEM WITH INTEGRATED WIND AND SOLAR ENERGY COLLECTION AND STORAGE

(71) Applicant: MIGHTY WAVES ENERGY, LLC., Gaithersburg, MD (US)

(72) Inventor: Douglas Wolfe, Gaithersburg, MD (US)

(73) Assignee: MIGHTY WAVES ENERGY, LLC., Gaithersburg, MD (US)

(21) Appl. No.: 19/543,379

(22) Filed: Feb. 18, 2026

Related U.S. Application Data
(60) Provisional application No. 63/761,321, filed on Feb. 21, 2025.

(51) Int. Cl. F03D 9/11; F03D 3/00; F03D 7/06; F03D 9/00; F03D 80/70

(52) U.S. Cl. CPC F03D 9/11; F03D 3/011; F03D 7/065; F03D 9/007; F03D 80/703

(57) ABSTRACT

A power generation platform includes a wind turbine assembly including a rotor and at least one blade coupled to the rotor. A support structure is configured to support the wind turbine assembly above a platform. At least one generator is disposed at a base of the support structure adjacent the platform, and a drive shaft is configured to mechanically couple the rotor and the at least one generator and transmit rotational energy from the rotor to the at least one generator.

### RELATED APPLICATIONS

This application is a non-provisional application and claims priority of U.S. provisional Application No. 63/761,321, filed Feb. 21, 2025, which is hereby incorporated herein by reference in its entirety.

### TECHNICAL FIELD

The present disclosure relates generally to power generation systems, and more particularly to a power generation system having integrated wind and solar energy collection and storage solutions.

### BACKGROUND

Wind energy is widely collected and used as a clean electricity source using conventional horizontal-axis wind turbines. Such horizontal-axis wind turbines, however, typically place a nacelle and generator at the top of a tall tower. This configuration can have large manufacturing, transportation, installation, and maintenance costs, and can require specialized equipment and personnel for servicing elevated drivetrain and electrical components.

Vertical-axis wind turbines, on the other hand, can offer advantages over such horizontal-axis wind turbines, such as accepting and harvesting wind energy from multiple directions without yaw control and potentially reducing certain wildlife concerns, such as the potential for bird strikes. However, vertical-axis designs have often faced challenges in achieving comparable efficiency relative to horizontal-axis systems, particularly across variable wind conditions.

Separately, solar energy installations and storage systems are frequently deployed as independent panel assemblies, which have increased land-use requirements, add complexity, and complicated transport and field deployment.

### SUMMARY

Accordingly, there remains a need for an economically competitive, integrated renewable energy solution that reduces turbine tower and maintenance burdens, supports efficient operation across a range of wind speeds, and combines wind generation with solar collection and on-site energy storage in a compact, deployable architecture. A power generation platform is therefore described herein that is configured to achieve each of these outcomes. Specifically, the power generation platform described herein employs a vertical-axis wind turbine coupled to a ground-level generator via a drive shaft, thereby reducing tower structural requirements and improving serviceability. The power generation platform described herein may additionally integrate air-diode turbine blades and/or a controllable bearing assembly for supporting the turbine shaft and regulating rotational speed of the turbine blades. The power generation platform described herein may additionally or alternatively incorporate solar panels and/or a base-housed energy storage system for a compact, integrated renewable energy solution.

According to an aspect of this disclosure, a power generation platform includes a wind turbine assembly including a rotor and at least one blade coupled to the rotor, a support structure configured to support the wind turbine assembly above a platform, at least one generator disposed at a base of the support structure adjacent the platform, and a drive shaft configured to mechanically couple the rotor and the at least one generator and transmit rotational energy from the rotor to the at least one generator.

According to an embodiment of at least one paragraph(s) of this disclosure, the wind turbine assembly is a vertical-axis wind turbine assembly, and the rotor is configured to rotate about a vertical axis.

According to an embodiment of at least one paragraph(s) of this disclosure, the at least one blade includes a plurality of blades circumferentially spaced about the rotor.

According to an embodiment of at least one paragraph(s) of this disclosure, the power generation system further includes a bearing assembly disposed between the drive shaft and the at least one generator and configured to support a weight of the wind turbine assembly and the drive shaft, without imparting an axial load on the at least one generator.

According to an embodiment of at least one paragraph(s) of this disclosure, the power generation system further includes a bearing assembly disposed between the drive shaft and the at least one generator and configured to regulate a rotational speed of the rotor and at least one blade.

According to an embodiment of at least one paragraph(s) of this disclosure, the bearing assembly includes a wheel bearing.

According to an embodiment of at least one paragraph(s) of this disclosure, the power generation system further includes a controller operatively connected to the bearing assembly for regulating the rotational speed of the rotor and at least one blade.

According to an embodiment of at least one paragraph(s) of this disclosure, the at least one blade is configured with an aerodynamic profile configured to permit airflow in a first direction while blocking airflow in a second direction, opposite to the first direction.

According to an embodiment of at least one paragraph(s) of this disclosure, the at least one blade includes a rigid frame and at least one flexible material to form the aerodynamic profile.

According to an embodiment of at least one paragraph(s) of this disclosure, the wind turbine assembly includes at least one cross member extending between the rotor and the at least one blade, respectively, and being configured to provide aerodynamic lift as the rotor and at least one blade rotate.

According to an embodiment of at least one paragraph(s) of this disclosure, the power generation system further includes an energy storage system disposed at the base of the support structure adjacent to the platform and electrically coupled to the at least one generator for storing energy produced by the at least one generator.

According to an embodiment of at least one paragraph(s) of this disclosure, the energy storage system includes at least one battery module.

According to an embodiment of at least one paragraph(s) of this disclosure, the power generation system further includes at least one solar panel mounted to the support structure.

According to an embodiment of at least one paragraph(s) of this disclosure, the at least one generator includes a plurality of generators, each of the plurality of generators being individually mechanically coupled to the rotor via the drive shaft such that the drive shaft is configured to independently transmit rotational energy from the rotor to each of the plurality of generators.

According to another aspect of this disclosure, a power generation system includes a wind turbine assembly including a rotor and at least one blade coupled to the rotor, a support structure configured to support the wind turbine assembly above a platform, a plurality of generators, each mounted to the support structure or the platform, and a drive shaft configured to individually mechanically couple the rotor to each of the plurality of generators and independently transmit rotational energy from the rotor to each of the plurality of generators.

According to an embodiment of at least one paragraph(s) of this disclosure, the wind turbine assembly is a vertical-axis wind turbine assembly, and the rotor is configured to rotate about a vertical axis.

According to an embodiment of at least one paragraph(s) of this disclosure, the at least one blade includes a plurality of blades circumferentially spaced about the rotor.

According to an embodiment of at least one paragraph(s) of this disclosure, the power generation system further includes a bearing assembly disposed between the drive shaft and the plurality of generators and configured to support a weight of the wind turbine assembly and drive shaft.

According to an embodiment of at least one paragraph(s) of this disclosure, the power generation system further includes a bearing assembly disposed between the drive shaft and the plurality of generators and configured to regulate a rotational speed of the rotor and at least one blade.

According to an embodiment of at least one paragraph(s) of this disclosure, the at least one blade is configured with an aerodynamic profile configured to permit airflow in a first direction while blocking airflow in a second direction, opposite to the first direction.

According to an embodiment of at least one paragraph(s) of this disclosure, the power generation system further includes an energy storage system disposed at the base of the support structure adjacent to the platform and electrically coupled to each of the plurality of generators for storing energy produced by the plurality of generators.

According to an embodiment of at least one paragraph(s) of this disclosure, the power generation system further includes at least one solar panel mounted to the support structure.

The following description and the annexed drawings set forth in detail certain illustrative embodiments described in this disclosure. These embodiments are indicative, however, of but a few of the various ways in which the principles of this disclosure may be employed. Other objects, advantages and novel features will become apparent from the following detailed description when considered in conjunction with the drawings.

### BRIEF DESCRIPTION OF DRAWINGS

The annexed drawings show various aspects of the disclosure.

FIG. 1 is a schematic diagram of a power generation system.

FIG. 2a is a perspective view of a drive shaft and generator according to an embodiment of the power generation system.

FIG. 2b is a perspective view of a bearing assembly according to an embodiment of the power generation system.

FIG. 3 is a schematic diagram of a blade profile of a wind turbine assembly.

FIGS. 4a-b are other schematic diagrams of a blade profile of a wind turbine assembly.

FIG. 5 is a schematic diagram of part of a power generation system having a plurality of generators.

FIG. 6 is a perspective view of a power generation system having a plurality of generators.

### DETAILED DESCRIPTION

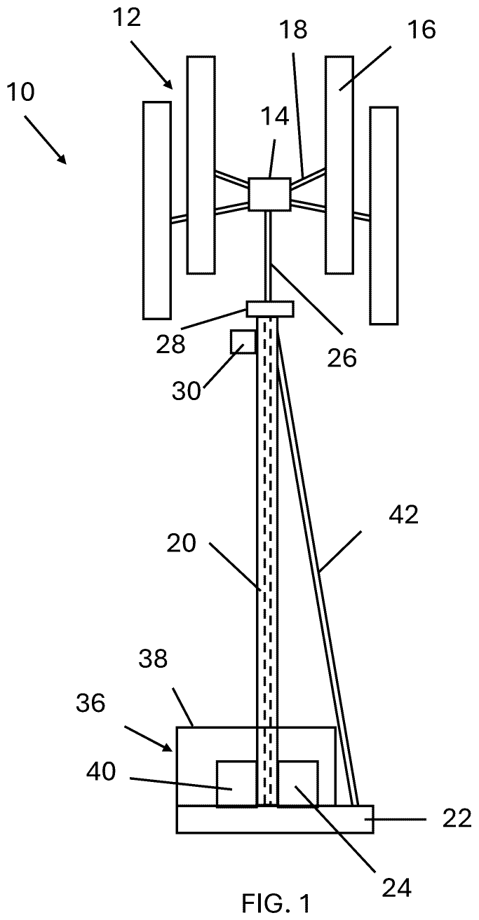

With reference to FIG. 1, an exemplary power generation system 10 according to an aspect of this disclosure is depicted. The power generation system 10 includes a wind turbine assembly 12 including a rotor 14 and at least one blade 16 coupled to the rotor. In the depicted embodiment, the wind turbine assembly 12 is a vertical-axis wind turbine assembly. The rotor 14 and, in turn, the at least one blade 16 are configured to rotate about a substantially vertical axis. Also, in the depicted embodiment, the at least one blade 14 includes a plurality of blades 16 circumferentially spaced about the rotor 14. While four equilaterally spaced blades 16 are depicted, it will be understood that any number of blades 16 may be provided and circumferentially spaced about the rotor 14. The wind turbine assembly 12 may also include at least one cross member 18, corresponding to each of the at least one blade 16, extending between and connecting the rotor with each of the respective at least one blade 16.

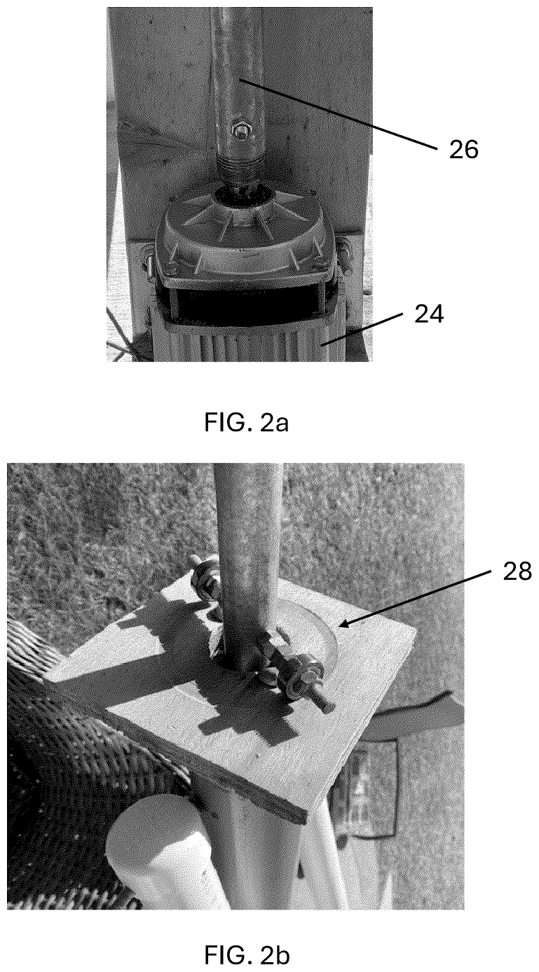

The power generation system 10 also includes a support structure 20, for example a shaft, configured to support the wind turbine assembly 12 above a platform 22 and/or the ground. At least one generator 24 is provided on the power generation system 10, for example, closer to or at a base of the support structure 20 adjacent the platform 22. The at least one generator 24, however, may be provided on the power generation system 10 at any location along the support structure 20. In any embodiment, a drive shaft 26 is provided on the power generation system 10 and is configured to mechanically couple the rotor 14 and each of the at least one generator 24 and transmit rotational energy from the rotor 14 to each of the at least one generator 24 to enable each of the at least one generator 24 to generate electrical power, accordingly. FIG. 2a depicts a close up view of an exemplary drive shaft 26 mechanically coupled to a generator 24. The drive shaft 26 may be coupled to the at least one generator in a vertical direct-drive configuration.

A bearing assembly 28 may be provided between the drive shaft and each of the at least one generator 24. The bearing assembly 28 may be, for example, a wheel bearing assembly, although other suitable bearing assemblies may additionally or alternatively be used. An exemplary wheel bearing assembly 28 is depicted in FIG. 2b. The bearing assembly 28 is configured to support a weight of the rotating components (e.g., the at least one blade 16) of the wind turbine assembly 12 and drive shaft 26, without imparting an axial load on the at least one generator 24, so that the weight of such is not borne directly by the at least one generator 24. Additionally, the bearing assembly 28 may be configured to regulate a rotational speed of the rotor 14 and each of the at least one blade 16. For example, the power generation system 10 may include a controller 30 operably coupled to the bearing assembly 28 for actively and/or passively controlling the rotational speed of the rotor 14 and each of the at least one blade 16, mitigating the risk of damage from high winds and damping resonant vibrations caused during operation of the wind turbine assembly 12, and allowing for optimization of energy capture across a range of wind speeds. The controller may be directly mounted on the power generation system 10 or may be provided remotely and controlled automatically and/or by a remote device. The bearing assembly 28 may be positioned close to a “hub” of the wind turbine assembly 12, or close to the rotor 14, and may be supported by a drive shaft support structure.

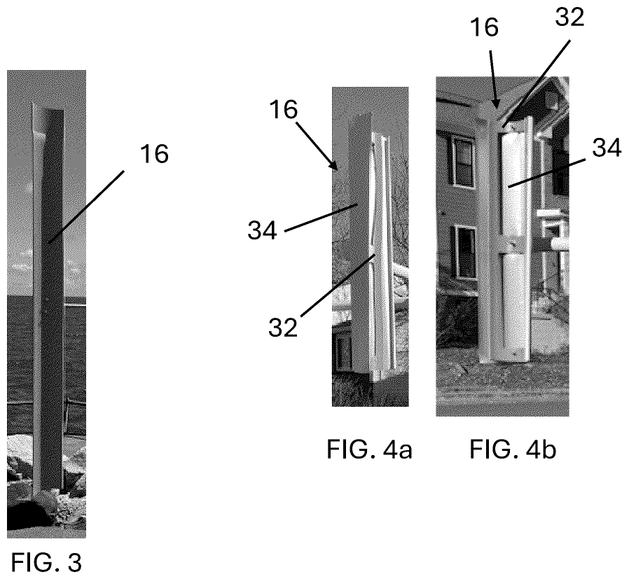

Turning to FIGS. 3-4b, each of the at least one blade 16 may be configured to have an aerodynamic profile or design, configured to permit airflow in a first direction while blocking airflow in a second direction, opposite to the first direction, thereby functioning as an air diode. This causes a differential drag that creates a net rotational force, causing the wind turbine assembly 12 to spin. In one embodiment, depicted in FIG. 3, the profile may be curved so that the at least one blade 16 catches air flow in one direction. As depicted in FIGS. 4a-b (FIG. 4a depicting a front peripheral view of the at least one blade 16, and FIG. 4b depicting a rear peripheral view of the at least one blade 16), each of the at least one blade 16 may additionally or alternatively include a rigid frame 32 and at least one flexible material 34 to form the aerodynamic profile. For example, each of the at least one blade 16 and/or the rigid frame thereof may be made of graphite or aluminum, and the flexible material 34 may include materials such as sail cloth or other fabric. The use of such materials and frame/flexible material design enhance the air diode effect and reduce the overall weight of the wind turbine assembly 12. Additionally or alternatively, each of the at least one cross member 18 may be configured and designed to provide aerodynamic lift, increasing lift with increasing rotational speed, further enhancing the air diode effect and reducing the overall weight of the wind turbine assembly 12.

The power generation system 10 may additionally include at least one energy storage system 36 electrically coupled to each of the at least one generator 24 for storing the electrical energy generated by each of the at least one generator 24. As depicted in FIG. 1, the at least one energy storage system 36 may be disposed at the base of the support structure 20 adjacent to the platform 22 and/or ground. Providing each of the at least one generator 24 and each of the at least one energy storage system 36 at the base of the support structure 20 adjacent to the platform 22 and/or ground contributes to the overall stability and lower center of gravity of the power generation system 10 and wind turbine assembly 12 supported above the platform 22 and/or ground, especially during operation with varying wind forces. However, it will be understood that the at least one energy storage system 36 may be provided elsewhere on the power generation system 10. The at least one energy storage system 36 may include a secure and environmentally controlled housing 38 and at least one energy storage module 40, for example a battery, for storing the electrical energy. The housing 38 may house and enclose both the at least one energy storage module 40 and each of the at least one generator 24 therein, and thereby provide environmental protection for the at least one energy storage module 40 and each of the at least one generator 24.

The power generation system 10 may additionally include at least one solar power generation system 42, for example including at least one solar panel, mounted to the support structure 20, as depicted in FIG. 1, or elsewhere on the power generation system 10. For example, the solar power generation system 42 may be supported by one or more tower struts extending from the support structure 20 to various heights above the platform 22 and/or ground, thereby maximizing solar energy capture and reducing the land use requirements, as compared to separate solar power installations. Solar energy captured by the solar power generation system 42 may be transferred to and stored by the at least one energy storage system 36 to contribute to the overall total energy capture of the power generation system 10.

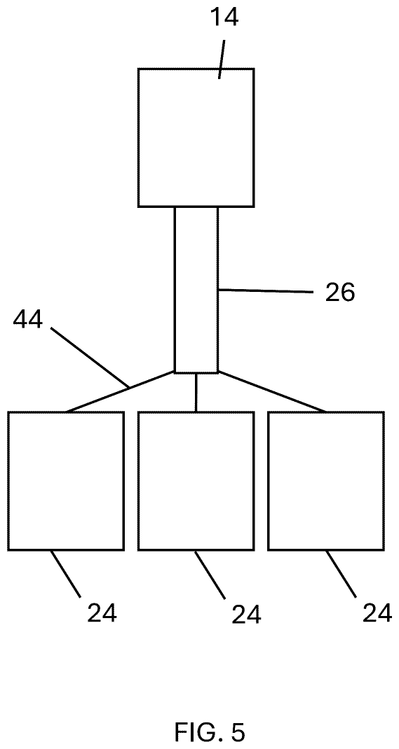

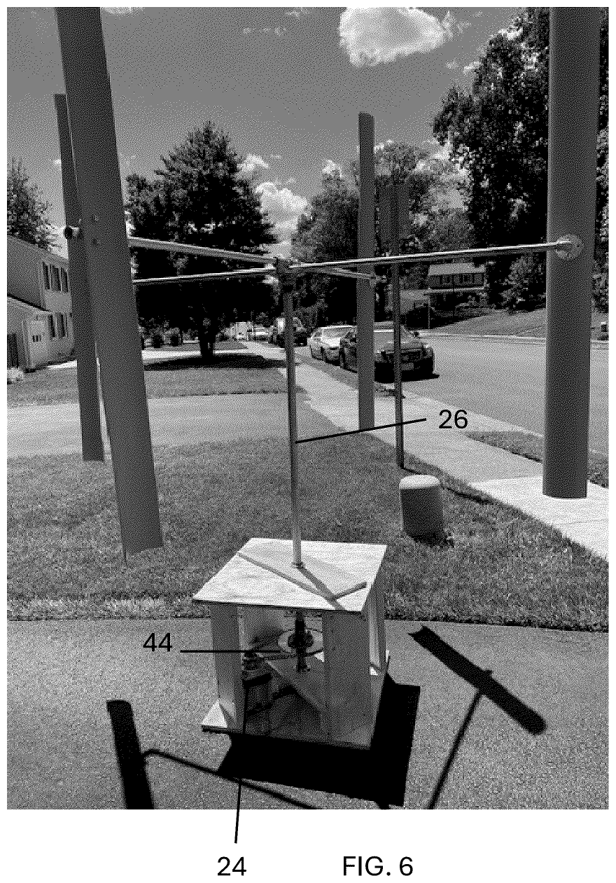

In some embodiments, as schematically depicted in FIG. 5 and perspectively depicted in FIG. 6, the power generation system 10 includes a plurality of generators 24 disposed at the base of the support structure 20, with each generator 24 being individually mechanically coupled to the rotor 14 via the drive shaft 26 such that the drive shaft 26 is configured to independently transmit rotational energy from the rotor 14 to each of the generators 24. The plurality of generators 24 may also be structurally coupled to the support structure base to enhance stability of the power generation system 10 overall. The drive shaft 26 may include one or more power takeoff portions 44 (e.g., sprockets, pulleys, or other torque-transfer interfaces) that deliver mechanical power to respective generators 24 through independent transmission elements, such as belts, chains, and/or gear trains. In certain implementations, each generator 24 is coupled to the drive shaft 26 through a respective clutch or other selective coupling mechanism such that each generator 24 can be independently engaged or disengaged from the drive shaft 26, for example to match one or more generator 24 efficiency curves to a current wind condition or to “kick in” additional generators 24 as wind speed increases. Each of the plurality of generators 24 may be offset from the drive shaft 26, as depicted in FIG. 6, so that multiple generators 24 may be arranged together.

Because each generator 24 is independently coupled, any individual generator 24 can be serviced, removed, or replaced without interrupting operation of the remaining generators 24. For example, a generator 24 may be decoupled from the drive shaft 26 (e.g., by disengaging its associated clutch and/or removing its associated belt or chain) and swapped for another generator 24 while one or more other generators 24 remain coupled and continue converting rotor power to electrical power. This modular, independently operable generator architecture may reduce downtime, improve maintainability, and enable efficient power generation across a wider range of wind speeds by selectively operating one generator 24, multiple generators 24, or different generator types based on desired performance characteristics.

The power generation system 10 may be sized and configured to be easily collapsible and transportable within a standardized ISO shipping container, for example, a standard 20-foot container or a standard 40-foot container. In this way, the power generation system 10 may be conveniently transported to a deployment site and assembled directly from the shipping container, the shipping container serving as the platform 22 and/or the environmentally controlled housing 38 of the power generation system 10. Otherwise, the power generation system 10 may be assembled on a separate platform 22 or directly on the ground.

In accordance with the above-described features, the power generation system 10 described herein provides an integrated wind, solar, and energy storage solution for electrical power generation, offering several advantages over current power generation systems. Due to the specific configuration, the support structure 20 of the power generation system 10 advantageously only needs to support the weight of the wind turbine assembly 12 (the rotor 14 and the blade(s) 16), significantly reducing material and construction costs. Additionally, having each of the at least one generator 24 at a base of the support structure 20 eliminates the need for specialized climbing equipment and complications associated with accessing the generator(s) for maintenance, repair, or replacement. Moreover, having the respective components positioned at the base of the support structure 20 further lowers the center of gravity and improves the overall stability of the power generation system 10.

Although the above disclosure has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments. In addition, while a particular feature may have been described above with respect to only one or more of several illustrated embodiments, such feature may be combined with one or more other features of the other embodiments, as may be desired and advantageous for any given or particular application.

What is claimed is:

1. A power generation system comprising:
a wind turbine assembly including a rotor and at least one blade coupled to the rotor;
a support structure configured to support the wind turbine assembly above a platform;
at least one generator disposed at a base of the support structure adjacent the platform; and
a drive shaft configured to mechanically couple the rotor and the at least one generator and transmit rotational energy from the rotor to the at least one generator.

2. The power generation system according to claim 1, wherein the wind turbine assembly is a vertical-axis wind turbine assembly and the rotor is configured to rotate about a vertical axis.

3. The power generation system according to claim 1, wherein the at least one blade includes a plurality of blades circumferentially spaced about the rotor.

4. The power generation system according to claim 1, further comprising a bearing assembly disposed between the drive shaft and the at least one generator and configured to support a weight of the wind turbine assembly and the drive shaft, without imparting an axial load on the at least one generator.

5. The power generation system according to claim 1, further comprising a bearing assembly disposed between the drive shaft and the at least one generator and configured to regulate a rotational speed of the rotor and at least one blade.

6. The power generation system according to claim 4, wherein the bearing assembly includes a wheel bearing.

7. The power generation system according to claim 4, further comprising a controller operatively connected to the bearing assembly for regulating the rotational speed of the rotor and at least one blade.

8. The power generation system according to claim 1, wherein the at least one blade is configured with an aerodynamic profile configured to permit airflow in a first direction while blocking airflow in a second direction, opposite to the first direction.

9. The power generation system according to claim 8, wherein the at least one blade includes a rigid frame and at least one flexible material to form the aerodynamic profile.

10. The power generation system according to claim 8, wherein the wind turbine assembly includes at least one cross member extending between the rotor and the at least one blade, respectively, and being configured to provide aerodynamic lift as the rotor and at least one blade rotate.

11. The power generation system according to claim 1, further comprising an energy storage system disposed at the base of the support structure adjacent to the platform and electrically coupled to the at least one generator for storing energy produced by the at least one generator.

12. The power generation system according to claim 11, wherein the energy storage system includes at least one battery module.

13. The power generation system according to claim 1, further comprising at least one solar panel mounted to the support structure.

14. The power generation system according to claim 1, wherein the at least one generator includes a plurality of generators, each of the plurality of generators being individually mechanically coupled to the rotor via the drive shaft such that the drive shaft is configured to independently transmit rotational energy from the rotor to each of the plurality of generators.

15. A power generation system comprising:
a wind turbine assembly including a rotor and at least one blade coupled to the rotor;
a support structure configured to support the wind turbine assembly above a platform;
a plurality of generators, each mounted to the support structure or the platform; and
a drive shaft configured to individually mechanically couple the rotor to each of the plurality of generators and independently transmit rotational energy from the rotor to each of the plurality of generators.

16. The power generation system according to claim 15, wherein the wind turbine assembly is a vertical-axis wind turbine assembly and the rotor is configured to rotate about a vertical axis.

17. The power generation system according to claim 15, further comprising a bearing assembly disposed between the drive shaft and the plurality of generators and configured to support a weight of the wind turbine assembly and drive shaft and configured to regulate a rotational speed of the rotor and at least one blade.

18. The power generation system according to claim 15, wherein the at least one blade is configured with an aerodynamic profile configured to permit airflow in a first direction while blocking airflow in a second direction, opposite to the first direction.

19. The power generation system according to claim 15, further comprising an energy storage system disposed at the base of the support structure adjacent to the platform and electrically coupled to each of the plurality of generators for storing energy produced by the plurality of generators.

20. The power generation system according to claim 15, further comprising at least one solar panel mounted to the support structure.
